(19) United States
(12) Patent Application Publication
(10) Pub. No.: US 2024/0119602 A1
(43) Pub. Date: Apr. 11, 2024

(54) MICRO-MOTION SENSING DEVICE AND SENSING METHOD THEREOF

(71) Applicant: HTC Corporation, Taoyuan City (TW)

(72) Inventors: Chun-Yih Wu, Taoyuan City (TW); Ta-Chun Pu, Taoyuan City (TW); Yen-Liang Kuo, Taoyuan City (TW)

(73) Assignee: HTC Corporation, Taoyuan City (TW)

(21) Appl. No.: 17/960,154

(22) Filed: Oct. 5, 2022

(51) Int. Cl. G06T 7/20; G01S 13/58; G01S 13/86; G06T 3/40; H04N 7/01

(52) U.S. Cl. CPC G06T 7/20; G01S 13/589; G01S 13/867; G06T 3/40; H04N 7/0127; G06T 2207/10016; G06T 2207/10044

(57) ABSTRACT

A micro-motion sensing device and a sensing method thereof are provided. The micro-motion sensing device includes a motion sensor, a motion classifier, and a render. The motion sensor receives an input radar signal and receives a video stream information through an image capturer. The motion sensor obtains velocity information and range information of an object according to the input radar signal, and generates a first video stream information by processing the video stream information according to the velocity information. The motion classifier generates a motion prediction information by classifying a motion of the object according to the velocity information, the range information, and the first video stream information. The render adjusts a rendered frequency of the first video stream information according to the velocity information.

### TECHNICAL FIELD

The disclosure relates to a micro-motion sensing device and a sensing method thereof, more particularly to a micro-motion sensing device applying an input radar signal and a sensing method thereof.

### DESCRIPTION OF RELATED ART

Dynamic frame rate rendering technique is mainly used to determine whether to increase the frame rate of video streams at a lower frame rate of image transmission by object prediction to smoothen the video display. In the conventional technique, the velocity vector of an object in the image is often calculated through the video stream, and frame interpolation is performed according to the velocity vector so as to improve the smoothness of the video.

Two main problems are encountered when dynamic frame rate rendering techniques are applied to track motions in micro-motion (e.g., facial expressions). First, it is difficult to use edge detection to detect subtle changes other than facial contours and facial features, so it is difficult to obtain the velocity vector. Second, the calculation performed by the velocity vector method requires a lot of power dissipation, and it is difficult to achieve the purpose of low power dissipation.

### SUMMARY

The disclosure provides a micro-motion sensing device and a sensing method thereof, which reduces the power dissipation during calculation and improves the fluency of motional video.

The micro-motion sensing device of the disclosure includes a motion sensor, a motion classifier, and a render. The motion sensor receives an input radar signal and receives a video stream information through an image capturer. The motion sensor generates a first video stream information by obtaining velocity information and range information of an object according to the input radar signal and processing the video stream information according to the velocity information. The motion classifier is coupled to the motion sensor and generates a motion prediction information by classifying a motion of the object according to the velocity information, the range information, and the first video stream information. The render is coupled to the motion classifier and adjusts a rendered frequency of the video stream information according to the velocity information.

The micro-motion sensing method of the disclosure includes: receiving an input radar signal and receiving a video stream information through an image capturer; obtaining velocity information and range information of an object according to the input radar signal; generating a first video stream information by processing the video stream information according to the velocity information; generating a motion prediction information by classifying a motion of the object according to the velocity information, the range information, and the first video stream information; and adjusting a rendered frequency of the video stream information according to the velocity information.

Based on the above, the disclosure determines a velocity of the micro-motion of the object according to the input radar signal and adjusts the rendered frequency of the video stream information of the object according to the velocity of the micro-motion of the object. For example, the input radar signal may directly express the velocity information, so the micro-motion sensing device of the disclosure may effectively reduce the required calculation amount and effectively reduce the required power consumption.

### BRIEF DESCRIPTION OF THE DRAWINGS

FIG. 1 is a schematic view of a micro-motion sensing device according to an embodiment of the disclosure.

FIG. 2 is a schematic view of a micro-motion sensing device according to another embodiment of the disclosure.

FIG. 3 is a diagram illustrating the relationship between the frame rate and the velocity information of the video stream information after downsampling according to an embodiment of the disclosure.

FIG. 4 is a flow chart of a micro-motion sensing method according to an embodiment of the disclosure.

### DESCRIPTION OF THE EMBODIMENTS

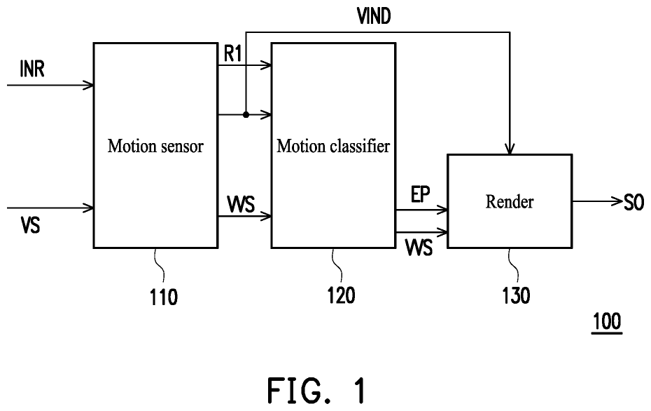

Referring to FIG. 1, FIG. 1 is a schematic view of a micro-motion sensing device according to an embodiment of the disclosure. The micro-motion sensing device 100 includes a motion sensor 110, a motion classifier 120, and a render 130. The motion sensor 110 is configured to receive an input radar signal INR and receive a video stream information VS through an image capturer. The motion sensor 110 obtains velocity information VIND and range information R1 of an object according to the input radar signal INR. The motion sensor 110 generates a first video stream information VVS by processing the video stream information VS according to the velocity information VIND. The input radar signal INR is a feedback signal generated by sending an electromagnetic wave to the object through a radar and according to the moving status of the object. The motion sensor 110 may obtain a position change status of the object in two dimensions based on the input radar signal INR, and then obtain the velocity information VIND of the object in one dimension. The motion sensor 110 may generate the range information R1 of the object by the position change status of the object.

In this embodiment, the micro-motion sensing device 100 may be used to detect facial expression changes of human. In this embodiment, the motion sensor 110 may generate the range information R1 of the feature objects (objects under test) on the face of human according to the input radar signal INR, such as the moving distance of the corner of the mouth. The velocity information VIND may be generated according to the input radar signal INR, such as the moving velocity of the corner of the mouth.

On the other hand, the motion sensor 110 may also receive video stream information VS generated by an image capturer. The image capturer may be a video camera or a camera, which is configured to shoot dynamic video for the object to obtain the video stream information VS. In this embodiment, the motion sensor 110 may further adjust the frame rate of the video stream information VS according to the velocity information VIND of the object, thereby generating the first video stream information VVS.

In detail, the motion sensor 110 may determine whether to perform a downsampling on the video stream information VS according to the velocity information VIND, thereby generating the first video stream information VVS. In response to the velocity information VIND indicating that the velocity of the object is lower than a reference value, the motion sensor 110 may perform the downsampling for the video stream information VS. The above reference values may be set by the designer according to actual needs, and are not limited thereto.

Further, the degree of frequency reduction may be adjusted according to the velocity of the object. For example, also taking the corner of the mouth of a human face as an object, in response to the corner of the mouth moving rapidly, the motion sensor 110 does not perform downsampling for the video stream information VS, and keeps the video stream information VS and the first video stream information VVS the same. In response to a slow velocity of the moving corner of the mouth, the motion sensor 110 may perform the downsampling for the video stream information VS according to a first frequency. In addition, in response to the corner of the mouth hardly moving, the motion sensor 110 may perform the downsampling for the video stream information VS according to a second frequency. The second frequency may be lower than the first frequency. In an embodiment of the disclosure, the second frequency may be as low as 10 hertz (Hz).

Through the downsampling, the micro-motion sensing device 100 may reduce the demand for the processing of high frequency signals and effectively reduce the power consumption generated by the signal processing.

On the other hand, the motion classifier 120 is coupled to a motion processor 110. The motion classifier 120 receives the first video stream information VVS, the velocity information VIND, and the range information R1 generated by the motion processor 110. The motion classifier 120 may generate motion prediction information EP by classifying the motion of the object according to the first video stream information VVS, the velocity information VIND, and the range information R1. Continuing with the above embodiments, taking the corner of the mouth of a human face as an object, for example, the motion classifier 120 may generate corresponding motion prediction information EP by predicting various changes in the facial expression of the human such as crying, laughing, or depressed according to the first video stream information VVS, velocity information VIND, and range information R1.

The render 130 is coupled to the motion classifier 120. The renderer 130 receives the motion prediction information EP and the first video stream information VVS. The render 130 is also configured to adjust a rendered frequency of the first video stream information VVS according to the velocity information VIND and the motion prediction information EP. The render 130 may generate multiple rendered frames according to the velocity information VIND and the motion prediction information EP, and generate output video stream information SO by inserting the rendered frames into the first video stream information VVS. The render 130 may bring the frame rate of the output video stream information SO to a target value, for example, 60 Hz, by inserting the rendered frames.

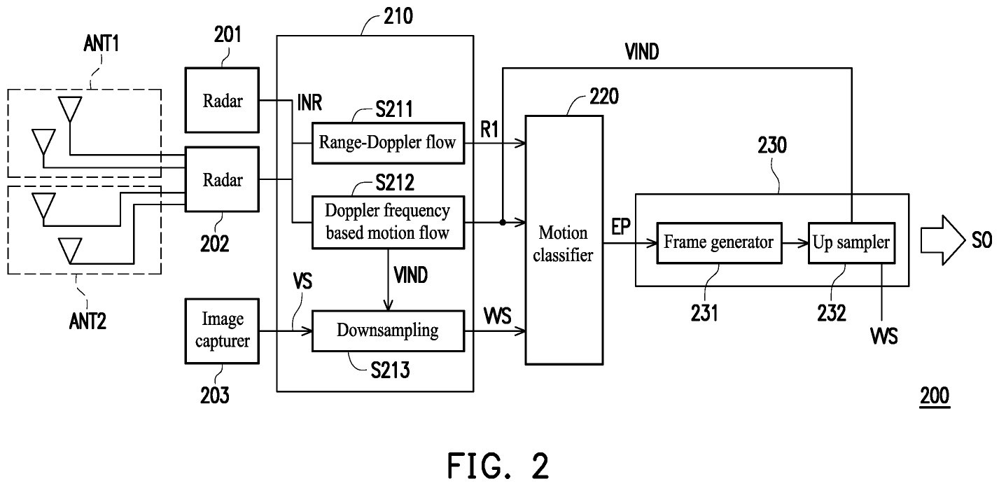

Referring to FIG. 2, FIG. 2 is a schematic view of a micro-motion sensing device according to another embodiment of the disclosure. The micro-motion sensing device 200 includes an antenna module ANT1, an antenna module ANT2, a radar 201, a radar 202, an image capturer 203, a motion sensor 210, a motion classifier 220, and a render 230. In this embodiment, the radar 201 may be an optical radar, coupled to the motion sensor 210. Radar 201 may generate input radar signal INR by performing optical detection on objects by optical methods. Radar 202 may be radio radar. The radar 202 is coupled to multiple antenna modules ANT1 and antenna modules ANT2, and generates input radar signal INR by transiting and receiving radio waves between objects through the antenna modules ANT1 and antenna modules ANT2. The image capturer 203 may be a video camera or a camera, which is configured to capture the motion of video frames of the object to generate video stream information VS.

The motion sensor 210 is coupled to the radar 201, the radar 202 and the image capturer 203. The motion sensor 210 obtains the range information R1 of the object by performing a Range-Doppler flow S211 for the input radar signal INR, and obtains the velocity information VIND of the object by performing a Doppler frequency based motion flow S212 for the input radar signal INR.

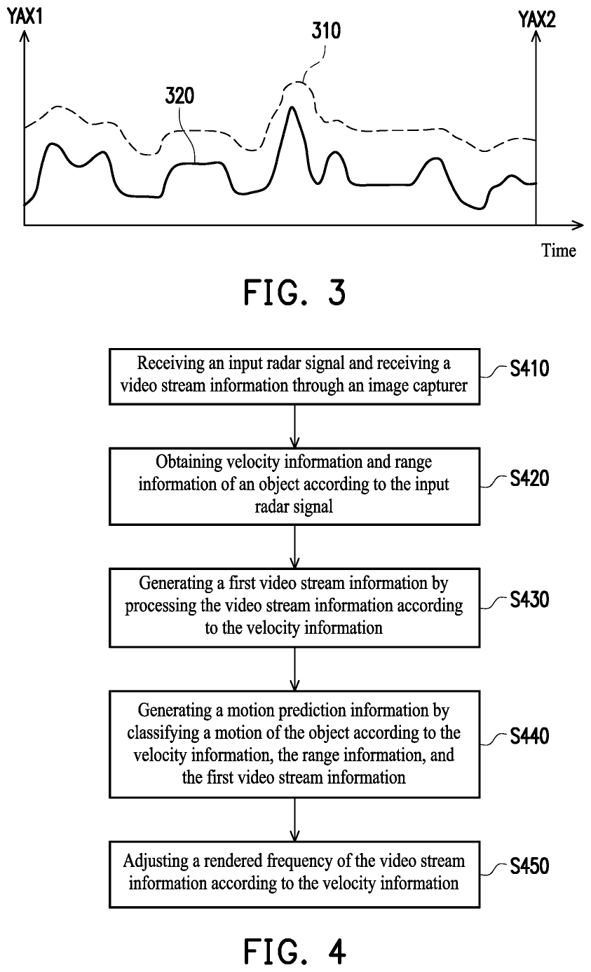

In addition, the motion sensor 210 performs the downsampling S213 on the video stream information VS according to the velocity information VIND, thereby generating the first video stream information VVS. The frame rate of the first video stream information VVS after downsampling may be positively correlated with the velocity information VIND, as shown in FIG. 3. FIG. 3 is a diagram illustrating the relationship between the frame rate and the velocity information of the video stream information after downsampling according to an embodiment of the disclosure.

In FIG. 3, the vertical axis YAX1 is the frame rate of video stream information, the vertical axis YAX2 is the velocity information of the object, and the lateral axis is time. Curve 310 corresponds to the vertical axis YAX2, and represents the velocity change of the object over time. The curve 320 corresponds to the vertical axis YAX1, and represents a change in the frame rate of the first video stream information VVS over time. It may be found from FIG. 3 that, through the downsampling S213 of the motion sensor 210, the frame rate of the first video stream information VVS may be positively correlated with the change in the velocity of the object over time. That is, the curve 320 may track the curve 310 to generate dynamic changes.

Referring to FIG. 2 again, the motion classifier 220 is coupled to the motion sensor 210 and receives range information R1, velocity information VIND, and first video stream information VVS. The motion classifier 220 may predict the motion of the object and generate the motion prediction information EP according to the range information R1, the velocity information VIND, and the first video stream information VVS. The motion prediction information EP may be facial expression information of human.

In addition, in this embodiment, the render 230 includes a frame generator 231 and an up sampler 232. The frame generator 231 may generate one or more rendered frames according to the motion prediction information EP. For example, in response to the motion prediction information EP indicating that the facial expression of the human is dull, the frame generator 231 may generate multiple rendered frames by copying a selected frame in the first video stream information VVS. In response to a drastic change in the facial expression of the human, the frame generator 231 may perform an interpolation according to consecutive frames in the first video stream information VVS to generate one or more rendered frames.

The up sampler 232 is coupled to the frame generator 231 and determines the number of rendered frames to be inserted into the first video stream information VVS according to the velocity information VIND, thereby generating the output video stream information SO. It is worth mentioning that no matter what the frame rate of the first video stream information VVS is, the up sampler 232 may perform super-sampling of the first video stream information VVS according to the velocity information VIND, and keep the frame rate of the generated output video stream information SO at the same target value (90 Hz).

Incidentally, in this embodiment, the motion sensor 210, the motion classifier 220, and the render 230 may be constructed using digital circuits. Alternatively, the motion sensor 210, the motion classifier 220 and the render 230 may use the same or different processors, which are implemented by executing software. The above-mentioned processor may be implemented by using any process circuit that is well-known to those skilled in the art and has computing capability, and there is no specific limitation.

In addition, the motion classifier 220 may also be implemented through a circuit that executes artificial intelligence, such as a neural network circuit. The neural network circuit may be a digital circuit or an in-memory operator, and are not limited thereto. In the implementation method of the neural network circuit, the designer may build a neural network model and use a variety of feature objects on the face of huma such as lips and eyes. The weight value is trained by capturing the moving range, velocity, and video features generated by each of the feature objects corresponding to different expressions, so that the training of the neural network circuit may be completed. The trained neural network circuit may then be applied to the motion classifier 220 of the embodiment of the disclosure.

Referring to FIG. 4, FIG. 4 is a flow chart of a micro-motion sensing method according to an embodiment of the disclosure. In step S410, an input radar signal is received and a video stream information is received through an image capturer. In step S420, velocity information and range information of an object is obtained according to the input radar signal. In step S430, a first video stream information is generated by processing the video stream information according to the velocity information. Furthermore, in step S440, a motion prediction information is generated by classifying a motion of the object according to the velocity information, the range information, and the first video stream information. In step S450, a rendered frequency of the first video stream information is adjusted according to the velocity information.

The implementation details of the above steps have been described in detail in the aforementioned embodiments, and will not be repeated here.

To sum up, the micro-motion sensing device of the disclosure determines a velocity of the micro-motion of the object according to the input radar signal and adjusts the rendered frequency of the video stream information of the object according to the velocity of the micro-motion of the object. By dynamically adjusting the frame rate of the video stream information of the process through the corresponding object velocity, the power consumption required by the micro-motion sensing device may be effectively reduced.

What is claimed is:

1. A micro-motion sensing device, comprising:
a motion sensor, configured to receive an input radar signal and receive a video stream information through an image capturer, wherein the motion sensor generates a first video stream information by obtaining velocity information and range information of an object according to the input radar signal and processing the video stream information according to the velocity information;
a motion classifier, coupled to the motion sensor and generating a motion prediction information by classifying a motion of the object according to the velocity information, the range information, and the first video stream information; and
a render, coupled to the motion classifier and adjusting a rendered frequency of the first video stream information according to the velocity information and the motion prediction information.

2. The micro-motion sensing device according to claim 1, wherein the motion sensor obtains the range information of the object by performing a Range-Doppler flow for the input radar signal and the velocity information of the object by performing a Doppler frequency based motion flow for the input radar signal.

3. The micro-motion sensing device according to claim 1, wherein the motion sensor determines whether to perform a downsampling on the video stream information according to the velocity information.

4. The micro-motion sensing device according to claim 3, wherein in response to a velocity of the object being lower than a reference value, the motion sensor performs the downsampling on the video stream information.

5. The micro-motion sensing device according to claim 1, wherein the render comprises:
a frame generator, configured to generate at least one frame according to the motion prediction information; and
an up sampler, generating an output video stream information by inserting one or more of the at least one frame into the first video stream information according to the velocity information.

6. The micro-motion sensing device according to claim 5, wherein a change in a frame rate of the first video stream information is positively correlated with a change in the velocity information.

7. The micro-motion sensing device according to claim 1, further comprising:
a first radar, coupled to the motion sensor and generating the input radar signal by sending a radio wave to the object.

8. The micro-motion sensing device according to claim 7, further comprising:
a second radar, namely, an optical radar, coupled to the motion sensor and generating the input radar signal by detecting the motion optically.

9. A micro-motion sensing method, comprising:
receiving an input radar signal and receiving a video stream information through an image capturer;
obtaining velocity information and range information of an object according to the input radar signal;
generating a first video stream information by processing the video stream information according to the velocity information;
generating a motion prediction information by classifying a motion of the object according to the velocity information, the range information, and the first video stream information; and
adjusting a rendered frequency of the video stream information according to the velocity information.

10. The micro-motion sensing method according to claim 9, wherein obtaining the velocity information and the range information of the object according to the input radar signal comprises:
obtaining the range information of the object by performing a Range-Doppler flow for the input radar signal; and
obtaining the velocity information of the object by performing a Doppler frequency based motion flow for the input radar signal.

11. The micro-motion sensing method according to claim 9, wherein generating the first video stream information by processing the video stream information according to the velocity information comprises:
determining whether to perform a downsampling on the video stream information according to the velocity information.

12. The micro-motion sensing method according to claim 11, further comprising:
performing the downsampling on the video stream information in response to a velocity of the object being lower than a reference value.

13. The micro-motion sensing method according to claim 9, wherein adjusting the rendered frequency of the video stream information according to the velocity information comprises:
generating at least one frame according to the motion prediction information; and
generating an output video stream information by inserting one or more of the at least one frame into the first video stream information according to the velocity information.

14. The micro-motion sensing method according to claim 13, wherein a change in a frame rate of the first video stream information is positively correlated with a change in the velocity information.
